(19) United States
(12) Patent Application Publication
(10) Pub. No.: US 2007/0254348 A1
(43) Pub. Date: Nov. 1, 2007

(54) METHOD FOR THE PRODUCTION OF FERMENTABLE SUGARS AND CELLULOSE FROM LIGNOCELLULOSIC MATERIAL

(76) Inventors: Theodora Retsina, Atlanta, GA (US); Vesa Pylkkanen, Atlanta, GA (US)

Correspondence Address: American Process Inc;Steve Rutherford, 750 Piedmont Avenue NE, Atlanta, GA, 30308, US

(21) Appl. No.: 11/740,923

(22) Filed: Apr. 27, 2007

Related U.S. Application Data
(63) Continuation of application No. 60/795,487, filed on Apr. 28, 2006.

(51) Int. Cl. C13K 1/02

(52) U.S. Cl. 435/161; 127/37

(57) ABSTRACT

A method for the production of fermentable sugars and cellulose from lignocellulosic material in a batch or continuous process. Lignocellulosic material is fractionated in a fashion that cellulose is removed as pulp, cooking chemicals reused, lignin is separated for the production of process energy, hemicelluloses are converted into fermentable sugars, while fermentation inhibitors are removed. High yield production of alcohols or organic acids can be obtained from this method using the final reaction step.

### FIELD OF THE INVENTION

This invention relates, in general, to the fractionation of lignocellulosic material into lignin, cellulose and hydrolyzed hemicelluloses and more particularly to the production of fermentable sugars from the hemicelluloses of a lignocellulosic material while preserving the production of cellulose in a continuous or batch process. The fermentable sugars can then be used as feedstock for a variety of chemical synthesis such as alcohols and organic acids.

### BACKGROUND OF THE INVENTION

Commercial sulfite pulping has been practiced since 1874. The focus of sulfite pulping is the preservation of cellulose. In an effort to do that, industrial variants of sulfite pulping take 6-10 hours to dissolve hemicelluloses and lignin producing a low yield of fermentable sugars. Stronger acidic cooking conditions that hydrolyze the hemicelluloses to produce a high yield of fermentable sugars also hydrolyze the cellulose and therefore the cellulose is not preserved.

Sulfite pulping produces spent cooking liquor termed sulfite liquor. Fermentation of sulfite liquor to hemicellulosic ethanol has been practiced primarily to reduce the environmental impact of the discharges from sulfite mills since 1909. Published design data from one of the two known remaining sulfite mills that produces ethanol, shows ethanol yields not to exceed 33% of original hemicelluloses. Ethanol yield is low due to the incomplete hydrolysis of the hemicelluloses to fermentable sugars and further compounded by sulfite pulping side products, such as furfural, methanol, acetic acid and others, inhibiting fermentation to ethanol.

Energy use for ethanol production in said sulfite mill applications is higher than the energy value of the ethanol produced. Furthermore, this sulfite process uses calcium sulfite or ammonium sulfite and has no chemical recovery, therefore chemical losses are high. Because of poor ethanol yield, lower cost of synthetic ethanol production, and the production of ethanol from corn today, only two sulfite mills are known to have continued the practice of hemicellulosic ethanol production to date.

In the 20^{th} century, Kraft pulping eclipsed sulfite pulping as the dominant chemical pulping method.

Kraft pulping however does not hydrolyze the hemicelluloses into fermentable sugars; instead hemicelluloses are in solution with soluble inorganic cooking chemicals and cannot readily be separated.

The number of sulfite pulp mills remaining in operation continues to reduce each year. The main reasons are that when compared to Kraft pulping, sulfite pulping produces inferior strength pulp, requires more cooking time, requires aged wood as the raw material (green wood cannot be readily used), is not feasible on as many different wood species, and lacks an efficient method of chemical recovery therefore chemical losses are high.

Other processes using solvent cooking chemicals have been tried as an alternative to Kraft or sulfite pulping. Original solvent processes are described in the U.S. Pat. No. 1,856,567 to Kleinert et al. and U.S. Pat. No. 2,060,068 to Groombridge et al. Although three demonstration size facilities for ethanol-water (ALCELL), alkaline sulfite with anthraquinone and methanol (ASAM), and ethanol-water-sodium hydroxide (Organocell) were operated briefly in the 1990's, today there are no full scale solvent pulping mills. None of these solvent processes provided for fermentable sugar production from hemicelluloses.

Groombridge shows that an aqueous solvent with sulfur dioxide is a potent delignifying system to produce cellulose from lignocellulosic material.

Furthermore, U.S. Pat. No. 5,879,463 to Proenca reveals that simultaneous delignification and rapid hydrolysis of the entire cellulosic material, both the cellulose and the hemicelluloses, is possible in the presence of an organic solvent and a dilute inorganic acid; however this process does not preserve the cellulose.

Therefore in the prior art of processing lignocellulosic material for the primary purpose of producing cellulose:

a) The sulfite processes to date (including base sulfite and ethanol sulfite) in an effort to preserve the cellulose, do not yield complete hydrolysis of hemicelluloses and produce fermentation inhibitors, thereby resulting in low yields of fermentable sugars in the sulfite liquor and furthermore, low yield of any downstream fermentation products from said sugars.
b) Strong acid processing of lignocellulosic material degrades and hydrolyzes both hemicelluloses and cellulose, therefore cellulose is not preserved.
c) The Kraft process does not hydrolyze hemicelluloses to fermentable sugars.
d) Organic solvent pulping methods did not hydrolyze hemicelluloses to fermentable sugars.
e) Treatment of lignocellulosic material with dilute inorganic acid in organic solvent hydrolyzes both cellulose and hemicelluloses and therefore does not preserve the cellulose.

The present inventors have now developed a method wherein the hemicelluloses of a lignocellulosic material can be converted to fermentable sugars while preserving the cellulose. A high yield of fermentable sugars can be obtained together with a cellulose product. Further it has been shown that the spent cooking liquor, termed hydrolyzate, produced according to the method of present invention can be used to produce high yields of ethanol. Surprisingly, ethanol production using hydrolyzate from the method of the present invention was 2.5 times higher than when using hydrolyzate that was not from the method of the present invention. This has been achieved through cooking lignocellulosic material with sulfur dioxide in a solution of ethanol and water in a one or multiple stage process where cooking is continued after intermediary removal of the cellulose. This can be done in a batch process with a cycle time of between 0.5 and 6 hours, or in a continuous process.

### BRIEF SUMMARY OF THE INVENTION

The present invention describes a process for the production of fermentable sugars by fractionating lignocellulosic material into lignin, cellulose and hydrolyzed hemicelluloses through a staged treatment of the lignocellulosic material with a solution of aliphatic alcohol, water and sulfur dioxide, in a one, two or multiple step process where the cellulose is removed and preserved in an intermediary step, the hemicelluloses are converted to fermentable sugars, and fermentation inhibitors are removed. Hence in a preferred embodiment lignocellulosic material is treated in a first stage with aliphatic alcohol, water and sulfur dioxide, the cellulose is then removed, and then a further treatment of the material is conducted with aliphatic alcohol, water and sulfur dioxide.

### BRIEF DESCRIPTION OF THE DRAWINGS

A more complete understanding of the present invention may be obtained by reference to the following detailed description when read in conjunction with the accompanying drawings wherein:

FIG. 1. Illustrates the products obtained from the fractionation of lignocellulosic material.

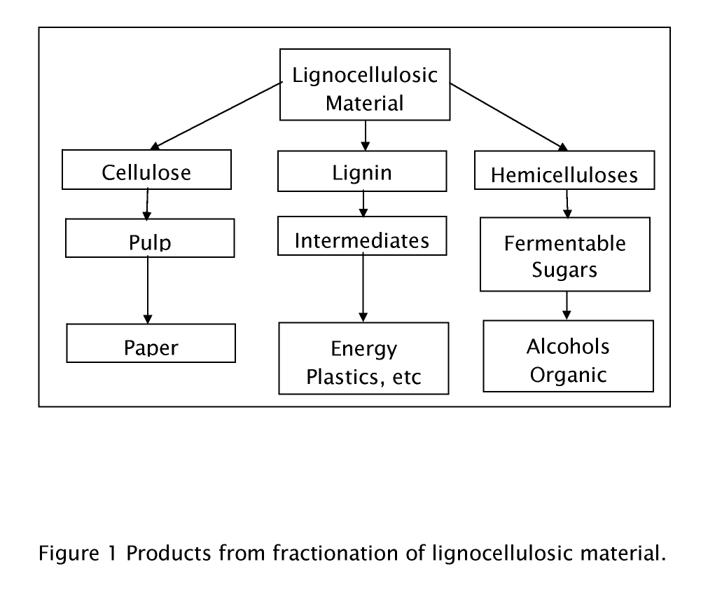

FIG. 2. Illustrates a flow sheet example of the invention process, noting that the process steps may be in other sequences.

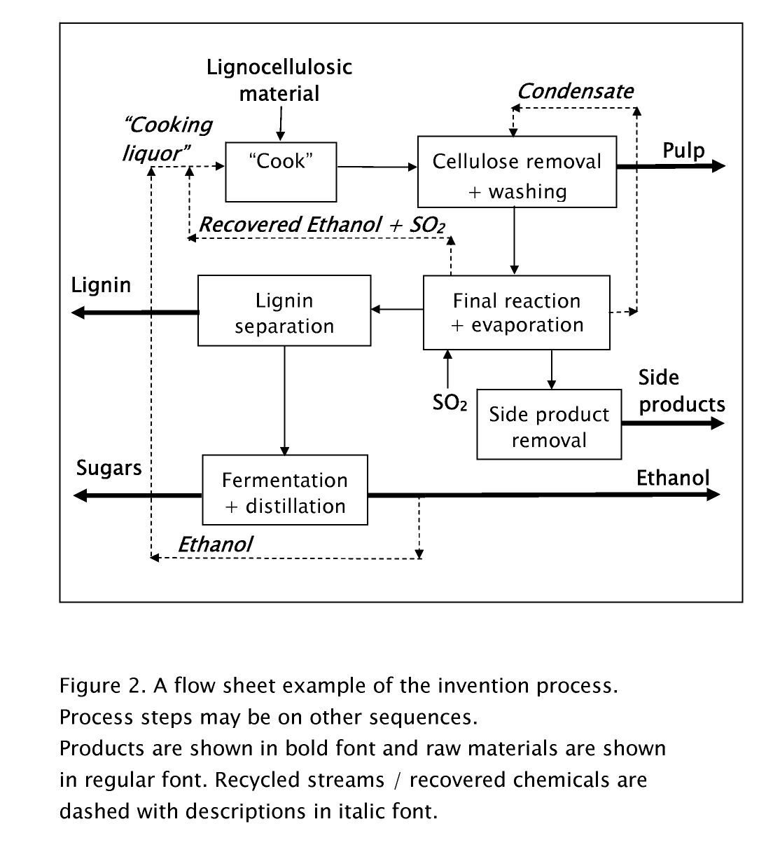

### DETAILED DESCRIPTION OF THE INVENTION

The first process step is “cooking” which fractionates the three lignocellulosic material components to allow easy downstream removal; specifically hemicelluloses are dissolved and over 50% are completely hydrolyzed, cellulose is separated but remains resistant to hydrolysis, and lignin is sulfonated in water soluble form. Lignocellulosic material is processed, “cooked”, in a solution of aliphatic alcohol, water, and sulfur dioxide where typical ratios by weight are 40-60% of both aliphatic alcohol and water, and 0.05-9% of sulfur dioxide, and preferably 50% aliphatic alcohol, 50% water, and 0.05-9% sulfur dioxide; this solution is termed cooking liquor. Aliphatic alcohols can include ethanol, methanol, propanol and butanol, but preferably ethanol. The cooking is performed in one or more stages using batch or continuous digesters. Depending on the lignocellulosic material to be processed, the cooking conditions are varied, with temperatures from 65° C. to 170° C., for example 65° C., 75° C., 85° C., 95° C., 105° C., 115° C., 125° C., 130° C. 135° C., 140° C. 145° C., 150, ° C., 155° C., 165° C. or 170° C., and corresponding pressures from 1 atmosphere to 15 atmospheres. The sulfur dioxide charge in the cooking liquor is varied between 0.05% and 9%, for example 0.05%, 0.1%, 0.5%, 1%, 2%, 2.5%, 3%, 3.5%, 4%, 5%, 6%, 7%, 8% or 9%, of the total cooking liquor mass in one or more cooking stages. Cooking time of each stage is also varied between 15 minutes and 360 minutes, for example 15, 30, 45, 60, 90, 120, 140, 160, 180, 210, 240, 270, 300, 330 or 360 minutes. The lignocellulosic material to cooking liquor ratio can is varied between 1:3 to 1:6, for example, 1:3, 1:4, 1:5 or 1:6, and preferably 1:4.

Hydrolyzate from the cooking step is subjected to pressure reduction, either at the end of a cook in a batch digester, or in an external flash tank after extraction from a continuous digester. The flash vapor from the pressure reduction is collected into a cooking liquor make-up vessel. The flash vapor contains substantially all the unreacted sulfur dioxide which is directly dissolved into new cooking liquor. The cellulose is then removed to be washed and further treated as required.

The process washing step recovers the hydrolyzate from the cellulose. The washed cellulose is pulp that can be used for paper production or other purposes. The weak hydrolyzate from the washer continues to the final reaction step; in a continuous digester application this weak hydrolyzate will be combined with the extracted hydrolyzate from the external flash tank

In the final reaction step, the hydrolyzate is further treated in one or multiple steps with a solution of aliphatic alcohol, water, and sulfur dioxide, sulfurous acid or sulfuric acid, where typical ratios by weight are 40-60% of both aliphatic alcohol and water, and sulfur dioxide, sulfurous acid or sulfuric acid to a charge of 0.05% and 9%, for example 0.05%, 0.1%, 0.5%, 1%, 2%, 2.5%, 3%, 3.5%, 4%, 5%, 6%, 7%, 8% or 9%, and directly or indirectly heated to temperatures up to 200° C., for example 105° C., 115° C., 125° C., 135° C., 140° C., 145° C., 150° C., 155° C., 160° C. 170° C., 180° C. 190° C. or 200° C., and preferably 140° C. Said solution may or may not contain residual alcohol. The final reaction step produces fermentable sugars which can then be concentrated by evaporation to a fermentation feedstock. Concentration by evaporation can be before or after the treatment with sulfur dioxide, sulfurous or sulfuric acid in said final reaction step. The final reaction step may or may not be followed by steam stripping of the resultant hydrolyzate to remove and recover sulfur dioxide and alcohol and for removal of potential fermentation inhibiting side products. The evaporation process may be under vacuum or pressure from −0.1 atmospheres to 3.0 atmospheres, for example 0.1, 0.3, 0.5, 1.0, 1.5, 2.0, 2.5, or 3.0 atmospheres. Alcohol is recovered from the evaporation process by condensing the exhaust vapor and is returned to the cooking liquor make-up vessel in the cooking step. Clean condensate from the evaporation process is used in the washing step. The hydrolyzate from the evaporation and final reaction step contains mainly fermentable sugars but may also contain lignin depending on the location of the lignin separation step in the overall process configuration, and is concentrated between 10% and 55% solids, for example 10%, 15%, 20%, 25%, 30%, 35%, 40%, 45%, 50% or 55%; this hydrolyzate continues to a subsequent process step.

Fermentable sugars are defined as hydrolysis products of cellulose, galactoglucomannan, glucomannan, arabinoglucuronoxylans, arabinogalactan, and glucuronoxylans in to their respective short-chained oligomers and monomer products, i.e., glucose, mannose, galactose, xylose, and arabinose, which are substantially free of fermentation inhibitors. In a preferred embodiment, this is a solution of monomer sugars essentially free of fermentation inhibitors. In a most preferred embodiment it is a solution of monomer sugars with concentration of furfural below 0.15% of the sugars.

The process lignin separation step is for the separation of lignin from the hydrolyzate and can be located before or after the final reaction step and evaporation. If located after, then lignin precipitates from the hydrolyzate since alcohol has been removed in the evaporation step. The remaining water soluble lignosulfonates are precipitated by converting the hydrolyzate to an alkaline condition using an alkaline earth oxide, preferably calcium oxide. The combined lignin and lignosulfonate precipitate is filtered. The lignin and lignosulfonate filter cake can be dried as a saleable byproduct or be burned or gasified for energy production. The hydrolyzate from filtering can be either be sold as a concentrated sugar solution product or be further processed in a subsequent fermentation step.

The process fermentation and distillation step is for the production of alcohols, most preferably ethanol, or organic acids. After removal of cooking chemicals and lignin, and treatment in the final reaction step, the hydrolyzate contains mainly fermentable sugars in water solution from which any fermentation inhibitors have been removed or neutralized. The hydrolyzate is fermented to produce dilute alcohol or organic acids, from 1% to 10% concentration. The dilute alcohol is distilled to concentrate to near to its azeotropic point of 95-96% by weight. Some of the alcohol produced from this stage is used for the cooking liquor makeup in the process cooking step. The majority of the alcohol produced is excess and is purified for saleable grade product.

The process side products removal step uses fractionation or separation techniques to remove side products from the hydrolyzate that are of economic value or accumulate to inhibit the yield and quality of the alcohol or pulp products. These side products are isolated by processing the vent from the final reaction step and the condensate from the evaporation step. Side products include furfural, methanol, and acetic acid.

Although other modifications and changes may be suggested by those skilled in the art, it is the intention of the inventors to embody within the patent warranted hereon all changes and modifications as reasonably and properly come within the scope of their contribution to the art.

### EXAMPLE

The following example illustrates the invention but in no way limits it:—

Wood chips of mixed northern pine species, containing 42.68% moisture, were cooked for 180 minutes at 157° C. in a 1 liter Parr reactor. The moisture adjusted cooking liquor consisted of 3% SO2, 48.5% of ethanol and 48.5% water by weight in 6 parts of total liquor to 1 part of dry wood.

Cellulose was removed representing 37.1% of the original wood mass.

The monomer sugars represented 61% of the all sugars in the hydrolyzate as determined by autoclaving the hydrolyzate with 4% H₂SO₄ in 121° C. for 60 minutes, which converted the remaining sugars in their corresponding monomers.

Half of the hydrolyzate was processed without the final reaction step. Calcium oxide was added to reach pH of 11 in the hydrolyzate and the precipitate containing calcium lignosulfonates was filtered off. The cooking ethanol was distilled off until the boiling point of the distillate reached 100.5° C. and density of 0.995 g/mL. The furfural content was determined to be 0.29 g/L in the untreated hydrolyzate after the lignin removal and evaporation step.

The second half of the hydrolyzate was subjected to the final reaction step by injecting 3% by weight of sulfur dioxide and heating for 30 minutes at 140° C. Calcium oxide was added to reach pH of 11 in the hydrolyzate and the precipitate containing calcium lignosulfonates was filtered off. The cooking ethanol was distilled off until the boiling point of the distillate reached 100.5° C. and density of 0.995 g/mL. The furfural content was determined to be 0.06 g/L in the hydrolyzate after the final processing step.

The untreated hydrolyzate, i.e., that was not subjected to the final reaction step, and the treated hydrolyzate, i.e., that was subjected to the final reaction step, were both prepared for fermentation by neutralizing with acetic acid, adding sodium citrate and commercial nutrient broth. Initial sugar composition and subsequent hydrolyzate composition were determined in HPLC.

Fermentation of both hydrolyzates was performed in a laboratory setting using saccharomyces cerevisiae yeast for at least 72 hours at 35° C.

The yield of ethanol from the untreated hydrolyzate corresponded to only 18.6% stoichiometric yield of the original oligomer sugars and monomer sugars present in the hydrolyzate.

TABLE 1
Monomer sugar concentration of the hydrolyzate and the product
ethanol concentration as a function of fermentation time for the untreated
hydrolyzate

| | | | | | | Total | |
|---|---|---|---|---|---|---|---|
| | Glucose | Xylose | Galactose | Arabinose | Mannose | Sugars | Ethanol |
| Fermerntation | Conc. | Conc. | Conc. | Conc. | Conc. | Conc. | Conc. |
| Time (hours) | (g/L) | (g/L) | (g/L) | (g/L) | (g/L) | (g/L) | (g/L) |
| 0 | 9.33 | 11.83 | 5.30 | 1.94 | 12.05 | 40.45 | 0.00 |
| 24 | 7.55 | 13.91 | 6.17 | 1.69 | 13.22 | 42.54 | 3.76 |
| 48 | 5.85 | 14.79 | 6.71 | 1.84 | 13.48 | 42.67 | 5.57 |
| 72 | 4.41 | 14.74 | 6.68 | 1.74 | 12.72 | 40.29 | 6.30 |

The yield of ethanol from the hydrolyzate treated in the final processing step corresponded to 46.5% stoichiometric yield of the original monomer and oligomer sugars in the hydrolyzate, or 2.5 times greater than the amount from the untreated hydrolyzate.

TABLE 2
Monomer sugar concentration of the hydrolyzate and the product
ethanol concentration as a function of fermentation time for the hydrolyzate
treated in the final reaction step.

| | | | | | | Total | |
|---|---|---|---|---|---|---|---|
| | Glucose | Xylose | Galactose | Arabinose | Mannose | Sugars | Ethanol |
| Fermerntation | Conc. | Conc. | Conc. | Conc. | Conc. | Conc. | Conc. |
| Time (hours) | (g/L) | (g/L) | (g/L) | (g/L) | (g/L) | (g/L) | (g/L) |
| 0 | 8.85 | 10.34 | 4.63 | 1.77 | 10.99 | 36.58 | 0.00 |
| 24 | 4.31 | 9.23 | 4.13 | 1.19 | 8.81 | 27.67 | 3.53 |
| 48 | 0.99 | 9.79 | 4.47 | 1.22 | 7.24 | 23.71 | 7.05 |
| 72 | 0.00 | 6.76 | 3.22 | 1.89 | 3.05 | 14.22 | 14.21 |

What is claimed:

1. A process for producing fermentable sugars from hemicelluloses of a lignocellulosic material through a staged treatment of the lignocellulosic material with a solution of aliphatic alcohol, water and sulfur dioxide with intermediate removal and preservation of cellulose.

2. A process according to claim 1 wherein said solution of aliphatic alcohol, water and sulfur dioxide contains 40% to 60% water.

3. A process according to claim 1 wherein a different concentration of said solution of aliphatic alcohol, water and sulfur dioxide is used at a first stage of treatment of said lignocellulosic material than is used in one or more subsequent stages of treatment with intermediate removal and preservation of cellulose.

4. A process according to claim 1 wherein a sulfur dioxide solution of 3% to 9% is used at a first stage of treatment and a sulfur dioxide, sulfurous acid or sulfuric acid solution of 0.05% to 9% is used in one or more subsequent stages of treatment with intermediate removal and preservation of cellulose.

5. A process according to claim 4 wherein said process is followed by steam stripping and/or evaporation of the hydrolyzate to remove and recover sulfur dioxide and alcohol and to remove fermentation inhibitors.

6. A process according to claim 1 wherein a sulfur dioxide solution of 0.05% to 3% is used at a first stage of treatment and a sulfur dioxide, sulfurous acid or sulfuric acid solution of 0.05% to 9% is used in one or more subsequent stages of treatment with intermediate removal and preservation of cellulose.

7. A process according to claim 6 wherein said process is followed by steam stripping and/or evaporation of the hydrolyzate to remove and recover sulfur dioxide and alcohol and to remove fermentation inhibitors.

8. A process according to claim 1 wherein said process is carried out at temperatures between 65° C. and 200° C.

9. A process according to claim 1 wherein said process is carried out at for a period of time between 15 minutes and 360 minutes.

10. A process according to claim 1 wherein preferred conditions are an initial treatment using 48% ethanol, 48% water and 4% sulfur dioxide at 140° C. for 2 hours, and following the intermediate removal and preservation of the cellulose, a final treatment 48.5% ethanol, 48.5% water and 3% sulfur dioxide at 140° C. for 1 hour.

11. A process for producing fermentable sugars from the hemicelluloses of a lignocellulosic material through a staged treatment of the lignocellulosic material with a solution of aliphatic alcohol, water and sulfur dioxide with intermediate removal of hydrolyzate and preservation of the cellulose.

12. A process according to claim 11 wherein a different concentration of said solution of aliphatic alcohol, water and sulfur dioxide is used at a first stage of treatment of said lignocellulosic material than is used in one or more subsequent stages of treatment with intermediate removal of hydrolyzate and preservation of the cellulose.

13. A process according to claim 11 wherein said process is carried out at for a period of time between 15 minutes and 360 minutes.

14. A process according to claim 1 wherein aliphatic alcohol is produced from fermenting and distilling the hydrolyzed fermentable sugars produced in said process and is then reused in said process.

15. A process according to claim 1 wherein lignin is sulfonated and rendered soluble in aqueous solutions.

16. A process according to claim 1 wherein the concentration of sulfur dioxide and aliphatic alcohol in the solution and the time of cook is varied to control the yield of hemicelluloses vs. celluloses and vs. fermentable sugars.

17. A process for producing hemicellulosic ethanol from lignocellulosic material through a staged treatment of the lignocellulosic material with a solution of aliphatic alcohol, water and sulfur dioxide comprising the steps of:
Cooking under acidic conditions to produce hydrolyzed hemicelluloses, cellulose, and sulfonated lignin;
Washing to separate lignin and hemicelluloses from cellulose in several stages to recover over 95% of the aliphatic alcohol mixed with the cellulose;
Treatment of post washing hydrolyzate with sulfur dioxide and heat to maximize the yield of fermentable sugars and to remove, and/or neutralize fermentation inhibitors;
Evaporation to remove and recover cooking chemicals, remove side products and concentrate lignin and/or fermentable sugars product;
Lignin separation to remove lignin and lignosulfonates from fermentable sugars
Fermentation and distillation to produce and concentrate alcohols or organic acids; and
Fractionation and/or separation to remove and recover side products.

18. A process for producing hemicellulosic ethanol comprising the steps of:
Producing fermentable sugars according to the process of claim 1; and
Subjecting the hydrolyzate to evaporation to remove and recover cooking chemicals and/or remove side products and/or concentrate lignin and/or concentrate hemicellusoses product.
A process according to claim 18 further comprising the step of fractionation and/or separation to remove and recover side products.
A process according to claim 18 further comprising the step of lignin and/or lignosulfonate separation.
A process according to claim 18 further comprising the step of fermentation and distillation.
